(19) United States
(12) Patent Application Publication
(10) Pub. No.: US 2023/0232746 A1
(43) Pub. Date: Jul. 27, 2023

(54) AGRICULTURAL PRODUCTS CLEANING MACHINE BY A SPIRAL CURTAIN CENTIFUGAL PROCESS

(71) Applicants: Otalicio PACHECO DA CUNHA, Sao Leopoldo (BR); Laides PORTO ALEGRE, Nao me Toque - RS (BR)

(72) Inventors: Otalicio PACHECO DA CUNHA, Sao Leopoldo (BR); Laides PORTO ALEGRE, Nao me Toque - RS (BR)

(21) Appl. No.: 18/005,026

(22) PCT Filed: Jul. 12, 2021
(86) PCT No.: PCT/BR2021/050297

§ 371 Date: Jan. 10, 2023

(30) Foreign Application Priority Data
Jul. 10, 2020 (BR) 102020014147-3

(51) Int. Cl. A01F 12/44; A01F 12/54

(52) U.S. Cl. CPC A01F 12/448; A01F 12/444; A01F 12/54

(57) ABSTRACT

The disclosure provided herein is directed to an agricultural products cleaning machine for cleaning agricultural products, such as grains in general, whereby the agricultural products are thrown against a sieve system with curved sieves in the shape of a volute by a grain transport and elevation system or bucket elevator. When thrown, the agricultural products move along as a spiral curtain which collides with the curved surface of the sieve, promoting the separation of agricultural products from impurities. The sieve allows adjustment of the mesh, so that a simple adjustment allows the separation of diverse agricultural products without having to change the sieve to a bigger or smaller mesh

### CROSS REFERENCE TO RELATED APPLICATION

This application claims the benefit of PCT Application Serial No. PCT/BR2021/050297 filed Jul. 12, 2021, which claims the benefit of Brazilian Patent Application Serial No. BR 1 0202001 41 47-3 filed Jul. 10, 2020, the contents of these applications are hereby incorporated by reference in their entirety.

### BACKGROUND OF THE INVENTION

This disclosure generally relates to a cleaning machine for agricultural products, for example, grains of corn, soybean, wheat, rice, sunflower, rapeseed, coffee, etc. More specifically, the disclosure relates to a cleaning machine for agricultural products whereby thee agricultural products are thrown into the form of a spiral curtain against a set of curved sieves resulting in a high grade of separation between impurities and grains

Cleaning operations for agricultural products, such as for grains, are made possible by vibratory sieves and flat oscillators, curved sieves, spiral sieves, and cylindrical sieves among others, whereby the grains are forced to pass through the sieve's mesh, resulting in the separation of grains from their impurities.

Regardless of the type of sieve used, this type of separation process produces many solid particulates that are suspended in the air. Because of this, various types of equipment for separation use sleeve filters, cyclones, and other means that aim to reduce the dust and particulate matter released into the environment from internal or external work done during the separating process.

Additionally, the sieves have specific meshes for each type of product being separated. A sieve used to separate coffee grains cannot be used to separate wheat. The equipment would allow the passage of all the grains of wheat along with their impurities without changing the coffee grain sieve to a wheat sieve.

There are separation devices known to address these shortcomings. These separation devices are composed of perforated sheets that overlap, that make it possible to regulate the opening for the passage of grain and retain the impurities. An example of sieves composed of perforated sheets that can vary the dimensions of the openings for the passage of grains is seen in document EP 1348495 which consists of at least two installed elements, one on top of the other, and with perforations for sieving. The elements are movable in relation to each other to alter the grade of sieving. The perforations for sieving of the various elements can have differing geometry and/or sizes or can be identical. The sieving elements are pressed together by means of fixation. The sieving elements can be cylindrical in their construction and formed as a sieving drum.

A separation device that uses a curved sieve similar to a volute can be seen in document CN 110560356 that divulges a sorting device of various stages for agricultural seeds comprising a feeding hopper and a sorting box, in which the center of the superior part of the sorting box is communicating with the feeding hopper, and the bottom of the feeding hopper extends to a sieving box. A multistage volute screen is in the sorting box.

Despite these advances and others, problems still remain. Thus it is a primary aspect of this disclosure to provide an agricultural products cleaning machine that improves upon the art.

These and other aspects, features, and advantages of the invention will become apparent from the specification and claims.

### SUMMARY OF THE INVENTION

The disclosure provides various aspects of an agricultural products cleaning machine.

Agricultural product cleaning equipment generates high doses of extremely toxic dust and particulate matter that stay suspended in the air and obligate manufacturers to use various methods of filtering the air. Also, manufacturers depend on diverse types of sieves to use on the diverse agricultural products that need to be cleaned before they are stored, commercialized, or processed. Additionally, the sieving processes use vibration, rotation, and/or translocation to separate grains from impurities

Due to the pertinent considerations of the state of the art previously discussed, it is one of the objectives of the now proposed invention, to develop an agricultural product cleaning machine, such as for grains in general, where the grains to be cleaned are thrown in a spiral centrifugal process against a unique sieving system in a set of three sieves tangentially overlapping, with one sieve being fixed and the others movable in the reverse inverse sense with curved sieves in spiral volute form. When the grains and impurities are thrown, they move along as a spiral curtain which collides with the curved surface of the sieve, promoting the separation of grains and impurities. The sieve set allows dimensional adjustments of the mesh, in the longitudinal and transversal directions allowing infinite dimensional adjustments of the sizes and shapes of the holes without the need to change the sieves for all the species of grains to be cleaned. The adjustment allows the separation of products according to their species without having to change the sieve to a bigger or smaller mesh.

Also, all the equipment is in a closed circuit, so that no dust escapes from the machine into the internal and/or external work environment

The characterization of the present invention is made by means of figures representing the Agricultural Products Cleaning Machine By The Spiral Curtain Centrifugal Process, in such a way that the product can be fully reproduced by adequate technique, allowing full functionality of the object claimed.

The descriptive part of the report is based on the elaborated Figures that articulate the preferred design of the invention. The descriptions are made through detailed and consecutive numbering that clarify the aspects that may be implied by the representation adopted in order to clearly determine the patent protection desired.

These Figures are merely illustrative and may have variations; as long as the variations do not deviate from the original claim.

### BRIEF DESCRIPTION OF THE DRAWINGS

FIG. 1 is a perspective view of an agricultural products cleaning machine according to an aspect of the disclosure;

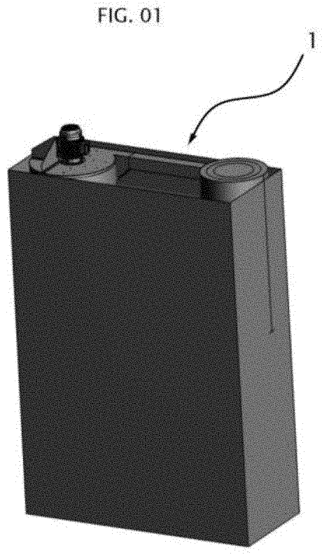

FIG. 2 is a perspective view of an agricultural products cleaning machine according to an aspect of the disclosure;

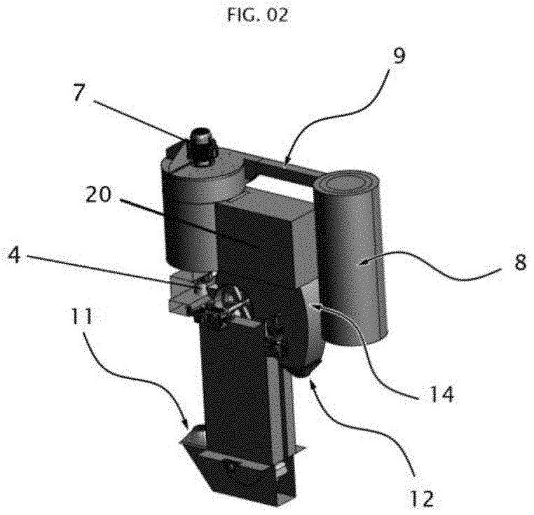

FIG. 3 is a perspective view of an agricultural products cleaning machine according to an aspect of the disclosure;

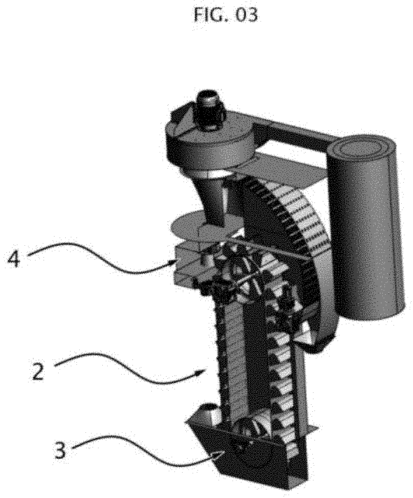

FIG. 4 is a perspective view of an agricultural products cleaning machine according to an aspect of the disclosure;

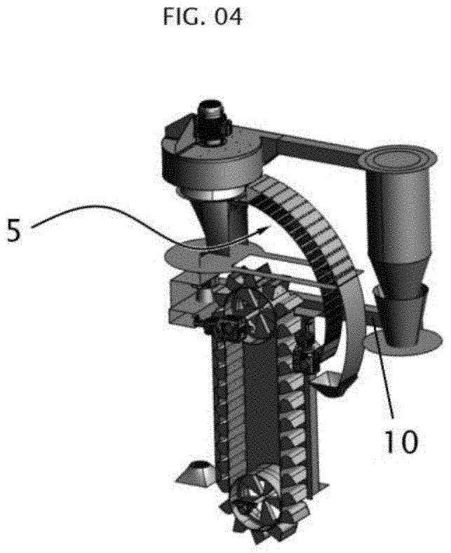

FIG. 5 is a perspective view of an agricultural products cleaning machine according to an aspect of the disclosure;

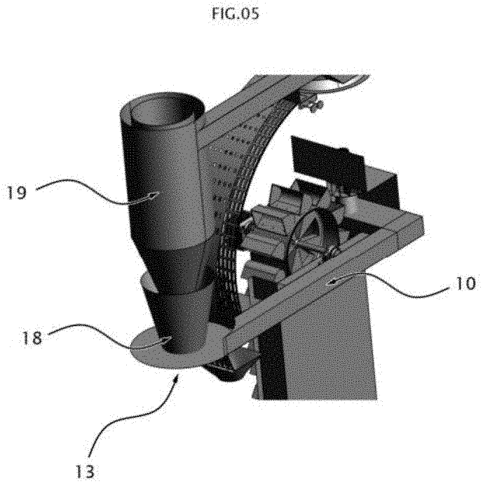

FIG. 6 is a perspective view of an agricultural products cleaning machine according to an aspect of the disclosure;

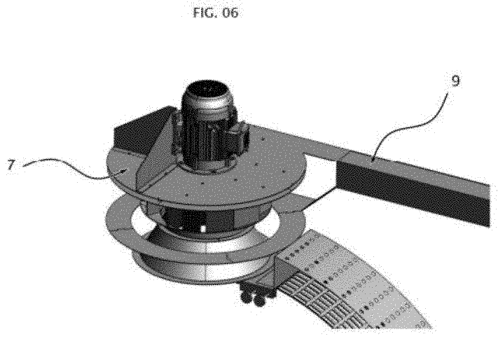

FIG. 7 is a perspective view of an agricultural products cleaning machine according to an aspect of the disclosure; and

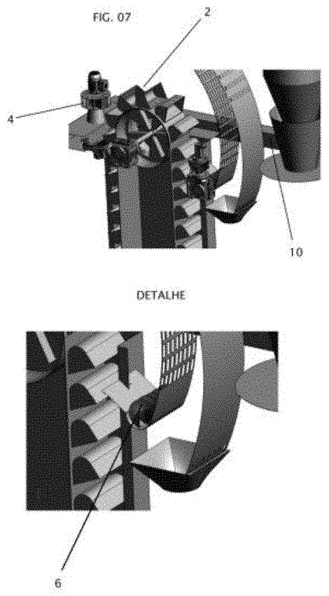

FIG. 8 is a perspective view of an agricultural products cleaning machine according to an aspect of the disclosure.

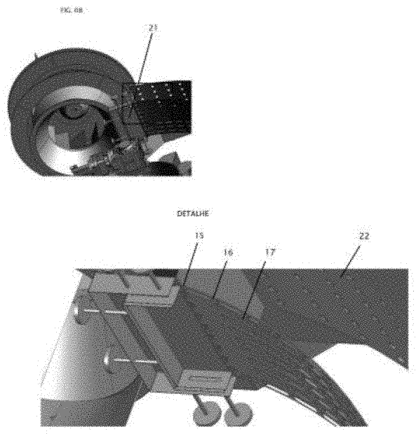

### DETAILED DESCRIPTION

The disclosure described herein is directed to different aspects of an agricultural products cleaning machine. The detailed description set forth below, in connection with the appended drawings, is intended as a description of various configurations and is not intended to represent the only configurations in which the concepts described herein may be practiced. These descriptions include specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

The disclosure is described herein with reference to certain aspects, iterations, embodiments, and examples but it is understood that the disclosure can be embodied in many different forms and should not be construed as limited to the aspects set forth herein. For example, the present disclosure makes reference to grains but should be interpreted as encompassing any agricultural product.

With reference to the Figures aspects of an agricultural products cleaning machine are shown according to the disclosure. The following nomenclature is used for the purpose of this disclosure:

a machine enclosure or covering (1), corresponding to the covering (1) that encloses the agricultural products cleaning machine;

a grain transport elevation system or bucket elevator (2);

a grain bin (3) by which grains or agricultural products are collected by the bucket elevator (2);

an inferior fan (4), such as a centrifugal type, positioned at the posterior end of the bucket elevator (2);

a sieve system (5) composed of at least three tangentially overlapping sieves (15, 16, and 17);

an extracting auger (6) for thick impurities;

a principle superior fan (7), such as a centrifugal type, positioned at the superior aspect of the sieve system (5) composed of the three sieves (15, 16, and 17);

a static gravitational separating decelerator or decelerator (8) for air/impurities/air;

a conduit (9) for impurities for the decelerator (8);

an air return duct (10) for the decelerator (8);

an entry inlet (11) for agricultural products, for example, grains for the bin (3);

an exit outlet (12) for clean agricultural products, for example, grains;

a gravity discharge outlet (13) of the impurities separated by the decelerator (8);

an internal body (14) that corresponds to the metallic covering that contains the sieve system (5);

a perforated funnel (18);

an internal separator (19);

a chamber or housing (20) for the insufflation and conduction of air for a perforated spiral volute or internal perforated volute or volute (22) that permeates the sieve system (5);

a regulating mechanism (21);

the perforated spiral volute or volute (22) of the inlet of air insufflated by the principle superior fan (7).

The bucket elevator (2) has variable speeds with rotations between 2 and 7 meters/second, so that the grains contained in the grain bin (3) are transported and ejected at the top of the conveyor, forming a sequence of thin, spiral-shaped, high-permeability grain curtains against the sieve system (5), where the grains are separated from the thicker impurities that are removed by means of the extracting auger (6) that is positioned at the bottom of said sieve system (5), and the at least three tangentially overlapping sieves (15, 16, and 17) being contained within the internal body (14).

The inferior fan (4) has the function of depressurizing the air in the decelerator (8) and reinjects this air into a closed circuit through the air return duct (10) into the internal body (14) where the sieve system (5) is located.

The superior fan (7) has the function of aspirating the air in the internal body (14), aspirating the impurities that are spirally centrifuged, directing them through the conduit (9) for fine particulates into the static gravitational separating decelerator (8) of air/impurities/air.

The sieve system (5) is composed of the at least three tangentially overlapping sieves (15, 16, and 17), with one being fixed and the others being movable with transverse and longitudinal course adjustment in the reverse inverse sense by way of a set of regulating mechanisms (21), that permit a millimetric range of subdivisions of overlap of the sieves, calibrating the holes for sieving the grains in accordance with the grain's species and granulometry. The sieve system (5) having the function of cleaning, separation by density, and/or just sieving of the agricultural product.

The conduit (9) for impurities is positioned orthogonally and laterally to the internal separator (19) which is located inside the decelerator (8) of air/impurities/air. The air flow used for the transport of separated impurities is aspirated or totally aspirated by the inferior fan (4) by way of the air return duct (10) that is positioned orthogonally and laterally to the perforated funnel (18), where the inferior fan (4) adjusts the rotational velocity for the equivalent flow received from the decelerator (8) in the closed circuit process with the objective of neutralizing positive pressures inside the decelerator (8) of air/impurities/air that permits gravitational discharge of all material through the gravity discharge outlet (13) without polluting the work environment.

The cooperation between the inferior fan (4) and the superior fan (7) makes up the ventilation system with variable rotation and flow and pressure generation capability in closed circuit with the objective of transporting materials with different grain or agricultural product densities, such as straw, pods, dry stalk, leaves, dust, shriveled grains, fine particulates, “bees wings” of corn, etc. The ventilation system separates the impurities with a fraction of the airflow, separating, transporting, and ejecting the impurities into the decelerator (8) of air/impurities/air, and, reusing this airflow, which is in a closed circuit throughout the process, avoiding any type of contamination to the workplace environment.

The closed-circuit air recirculation system is composed of the internal body (14), the decelerator (8), the conduit (9) of fine particulates, the chamber or double airduct (20) for air insufflation for the internal perforated volute (22) and the air return duct (10) which aspirates the air of the decelerator (8) and with high velocity injects the posterior superior aspect of the bucket elevator (2) with all material to be cleaned, with the objective of making the mass of the product extremely permeable at the moment in which the bucket elevator (2) ejects the grains to form jets of spiral curtains.

The closed-circuit air recirculation system has a ventilation set composed of the inferior fan (4) and the superior fan (7) with variable rotation devices that permit precise adjustment and synchronization of the volume and pressure of air of both fans (4 and 7) to accomplish the objectives. The superior fan (7) functions to generate flow and pressure to separate the impurities in the jets of the spiral curtains, also to aspirate and separate internally the air impurities in a pneumatic/centrifugal/mechanical process, whereby, the impurities are directed to the decelerator (8) that separates the air impurities for recirculation in a closed circuit.

In the closed-circuit air recirculation system, the principle superior fan (7) will generate and direct clean air through both sides of the superior section of the housing (20). The housing (20) contains a horizontal divider becoming an airduct that interconnects the discharge of the air of the superior fan air (7) and the internal perforated volute (22), where the internal perforated volute (22) is the entrance for air entering the internal body (14). This volume of air goes through the three sieves (15, 16, and 17) to permeate the grain curtains and remove all types of impurities that will be discarded; the impurities, of which, are separated in the principle superior fan (7) and injected into the decelerator (8).

The enclosure of the agricultural products cleaning machine within the covering (1) eliminates cyclones and sleeve filters while occupying less space than conventional machines used for equivalent production. the agricultural products cleaning machine according to aspects of the disclosure has less operational intervention in regard to settings and function

Therefore, an agricultural products cleaning machine has been provided that improves upon the art and accomplishes one or more of the stated objectives among other advantages.

From the above discussion and accompanying figures and claims it will be appreciated that the agricultural products cleaning machine offers many advantages over the prior art. Although the present disclosure and its advantages have been described in detail, it should be understood that various changes, substitutions, modifications, and alterations can be made herein without departing from the technology of the disclosure as defined by the appended claims. The scope of the present application is not intended to be limited to the particular configurations of the process, machine, manufacture, composition of matter, means, methods and steps described in the specification only expressly stated otherwise. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein

What is claimed is:

1. AGRICULTURAL PRODUCTS CLEANING MACHINE BY THE SPIRAL CURTAIN CENTRIFUGAL PROCESS is characterized by being totally enclosed by a covering (1), containing the grain transport and elevation system or the bucket elevator (2) and working with the grain bin (3) in which grains are collected by the bucket elevator (2). Also characterized by an inferior centrifugal fan positioned at the posterior end of the bucket elevator (2), a sieving system composed of three overlapping sieves (5), an extracting auger for thick impurities (6), a principle centrifugal superior fan (7) positioned at the superior aspect of the sieving system (5), a static gravitational separating decelerator for air/impurities/air (8), a conduit for impurities (9) for the decelerator (8), a decelerator (8) return air duct (10), an entry inlet (11) for agricultural products such as grains for the bin (3), an exit outlet (12) for clean agricultural products such as grains, a gravity discharge outlet (13) of the impurities separated by the decelerator (8), and an internal body (14) that corresponds to the metallic covering that contains the sieving system (5).

2. CLEANING MACHINE FOR AGRICULTURAL PRODUCTS, in accordance with claim 1, is characterized by the bucket elevator (2) with variable peripheral speeds with rotations between 2 and 7 meters/second, so that the grains contained in the bin (3) are transported and ejected at the top of the elevator, forming a sequence of thin, spiral-shaped, high-permeability grain curtains against the sieving system (5).

3. CLEANING MACHINE FOR AGRICULTURAL PRODUCTS, in accordance with claim 2, is characterized by a sieving system (5) composed of an overlapping set of three sieves (15, 16, and 17), with one being fixed and the others being movable with transverse and longitudinal course adjustment by way of a regulating mechanism (21) whereby the thicker impurities are removed by the extracting auger (6) that is positioned in the inferior aspect of the sieving system (5).

4. CLEANING MACHINE FOR AGRICULTURAL PRODUCTS, in accordance with claim 3, is characterized by the static gravitational separating decelerator of air/impurities/air (8) that operates in synchronization with the conduit of impurities (9) that is positioned orthogonally and laterally to the internal separator (19) and with a return air duct that is positioned orthogonally and laterally to the funnel (18).

5. CLEANING MACHINE FOR AGRICULTURAL PRODUCTS, in accordance with claim 4, is characterized by the inferior fan (4) having a rotational speed adjustment for the equivalent flow received from the particulate decelerator (8).

6. CLEANING MACHINE FOR AGRICULTURAL PRODUCTS, in accordance with claim 5, is characterized by the closed-circuit air recirculation system composed of the internal body (14), the decelerator (8), the conduit of fine particulates (9), double airduct for air insufflation (20) for the internal perforated volute (22) and the air return duct (10).
